(19) United States
(12) Patent Application Publication
(10) Pub. No.: US 2005/0229006 A1
(43) Pub. Date: Oct. 13, 2005

(54) Digital sealer apparatus

(76) Inventors: Eduardo Rosemberg De Moura, Rio de Janeiro (BR); Morcio Campos de Lima, Rio de Janeiro (BR)

Correspondence Address: MARSH, FISCHMANN & BREYFOGLE LLP, 3151 SOUTH VAUGHN WAY, SUITE 411, AURORA, CO, 80014, US

(21) Appl. No.: 10/521,977

(22) PCT Filed: Jul. 23, 2003
(86) PCT No.: PCT/BR03/00101

§ 371 Date: Jan. 21, 2005

(30) Foreign Application Priority Data
Jul. 23, 2002 (BR) PI0202843-3

(51) Int. Cl. H04K 1/00

(52) U.S. Cl. 713/186

(57) ABSTRACT

The present invention is related to digital certification; more particularly, this invention develops new methods and apparatus for digitally signing documents in a computer device, from the positive identification of persons, through the use of bio-metric techniques, specifically of fingerprint, and associated to the use of smart cards.

### BACKGROUND OF THE INVENTION

1. Field of Invention

The digital world is emerging at unprecedented speed in human history; governments, companies and citizens of this new society need a mean to guarantee electronic transactions privacy and authenticity performed at distance. The digital sealer apparatus (from now on, for the sake of simplicity, simply named Sealer Device) is a new type of apparatus that uses biometry techniques, specifically of fingerprint, to positively identify a person and, in a digital way, to encrypt, decrypt, sign, authorize and check electronic transactions and documents authenticity, utilizing public key cryptography, signature and digital certification techniques.

In view of this, the present invention refers to cryptography, digital signature and certification; more particularly, this invention develops new and improved methods and apparatus to encrypt, decrypt, check and sign documents, in digital manner, in a computer device, starting from positive identification of persons, through the use of biometric techniques, specifically of fingerprints, associated do the use of smart cards.

2. Description of the Prior Art

Nowadays several systems exists to digitally protect and authenticate (in a digital manner, using techniques of computer and cryptography) a document, aiming at legally validating it within the electronic world, specially in commercial transactions linked to facilities implemented by the use of Internet.

In these systems, a user wanting to obtain a digital certificate, (DC) emitted by a certification authority (CA), shall present itself to a registration authority (RA), provided with documents proving his identity in the real world (taxpayer i.d., identity card, etc.). By this form, the RA, proving the legitimacy of the proofs presented by the user, issues a Digital Certificate Sign Request (CSR) for a CA, signing the CSR with its respective digital signature (DA). From there on, the CA, trusting in information witnessed by RA, issues a DC for this user.

A digital certificate (DC) is nothing more than a set of computer's data, generated in conformance with the International Recommendation ITU-T X.509, destined to record, in unique, exclusive and untransferable form, the relation existing between a pair of asymmetric cryptographic keys and its title-holder, in conformity with a Certifying Authority.

Cryptography is the set of principles, means and methods for messages (data) transformation in unintelligible data and vice-versa, protecting its content against non-authorized access. Only those who are in knowledge of the employed cryptographic keys used to encrypt the messages are able to “read” them, using these keys to return the unintelligible data (encrypted) to its original state.

The cryptography may be symmetrical (or of secret key), where only one key is used both to encrypt (turn unintelligible) and to decrypt (turn intelligible again) the information, or asymmetric (or of public key), where a pair of cryptographic keys is used who are asymmetric as to their functionality (all information that is encrypted with one of the keys may only be decrypted with the other one). One of the keys of this pair (the public key) shall stay available for any person willing to encrypt information that may be “readout” only by the title-holder user of this pair of keys. In the same form, this public key shall remain available so that any person may check a created digital signature, with the corresponding private key, by the title-holder user of this pair of keys. The title-holder shall maintain the private key in total secret; it is the main secret of this “safe”. It allows its title-holder user to decrypt messages addressed to him and sign his messages digitally.

The cryptographic public key is in the DC proper. The private key shall remain under the exclusive guard of the DC's title-holder in a trusted magnetic means.

The title-holder user shall have the maximum care with its private key as anyone having access to it may digitally sign any electronic document in his name, besides being able to decrypt documents addressed to him.

The private key and the digital certificate are installed in user's computer, usually locally stored in the hard disk or in a diskette.

From there on, when the user needs to send a document through the net, guaranteeing its originality (its integrity and its origin), be will submit this document to a computer's process of digital signature.

The digital signature is a process created by the generation of a summary record of the original document (through the use of a hash function based on irreversible cryptographic techniques). This summary record of the original document is encrypted, using the private key of the author or sender of this document, originating the digital signature of the document. This digital signature proves the originality of document, since it binds its original content (used to obtain the summary record) and the cryptographic private key of its author or sender (used do encrypt the summary record obtained in former step). This is similar to the real world, when we sign a document, in one's own handwriting, to authenticate the same in written.

A hash function, based on irreversible cryptographic algorithm, applied to a document or message, is able to summarize the whole content in a sole number (summary of document or message) so that, always when applied to this document or message, the same number (or summary) will be obtained. This function has his fundamental properties: it is not possible to return to the original document or message from its summary (number); and it is unique, there being no other documents or messages that result in this same number (or summary). Even making a minimum change in the document or message and applying the hash function in this document or message, a distinct number or summary will be generated from that one generated in its application to the original document or message.

The present systems show some vulnerable points that may endanger the safety and reliability of this process.

The first one is the user's identification method proper. The highest his honesty may be and the highest the care that a recording authority may have, it never will be possible to guarantee that the documents and probes presented about the user's identity will be exempt of fraud, i.e., that this person that is being physically introduced will be in fact that one that appears in the documents.

Besides this, the private key remains stored in a low safety-processing environment (normally in the user's personal computer), which may be very easily accessed and violated.

Finally, the digital signature process is also effectuated in a low safety processing environment and a violable one, with low protection against non-authorized access to the private key. This allows that a person, who is not the title-holder user, with evil intentions or not, is able to issue an electronic document in that computer or, even to fraud, to adulterate, to counterfeit or to corrupt a document signed by the legitimate title-holder of that private key and corresponding digital certificate.

Looking for to diminish these vulnerabilities, several solutions were made available in the market, attenuating its consequences or even solving some of these situations in an isolated form.

A simple form of protecting the digital signature process is the mechanism of access password. This solution is amply spread but presents also safety problems such as: its disclosure, intentional or not (this password may be maliciously copied, disclosed or discovered), through systematic trials or by its capture by keyboard interception mechanisms of the computer.

Searching to eliminate these deficiencies, some biometric identification solutions appeared, since these mechanisms make use of person's physical characteristics to make sure the legitimacy of its identification. By this form, identification is made not more through information known by persons (as a password, as above disclosed), but through something that they are the sole bearer. An example of this is the fingerprint which is clearly a unique characteristic of a human being and really untransferable. This access method, besides identifying, also authenticates a person, as only be possesses that specific fingerprint.

This access mechanism practically solves the identification and authentication problem in the access and production of a digital signature.

However, one of the most important aspects still lacks a definitive solution: the inviolability of the digital signature-processing environment. Solutions were presented in which the digital signature process is performed in an external device, supposedly secure, that processes the digital signature extracting the private key resident in user's computer (vulnerable environment).

The most widespread solution for the inviolability question is the use of smart cards as private key and user's digital certificate generators and storage.

### SUMMARY OF THE INVENTION

The present invention provides new and improved techniques for digital signature with defined procedures within an autonomous computer device.

### BRIEF DESCRIPTION OF THE DRAWINGS

Through basic diagrams, the most important processes of the several embodiments of the digital sealer device are specified, and the logic structure of apparatus and fundamental methods for the digital signature process is detailed. Therefore:

FIG. 1 describes the components of the digital sealer device;

FIG. 2 describes and details the hardware modules that constitute the digital sealer device;

FIG. 3 describes and details the software modules that constitute the digital sealer device;

FIG. 4 describes and details the software modules that constitute the host of the digital sealer device;

FIG. 5 is a flowchart describing a secure programming interface of the present invention.

FIG. 6 is a flowchart describing the structural and functional aspects of the smart card used in the present invention;

FIG. 7 describes the cadastering method of a fingerprint according to the present invention;

FIG. 8 describes the digital signature method through the use of a fingerprint according to the present invention.

### DETAILED DESCRIPTION OF PREFERRED EMBODIMENTS

Description of the Sealer Device for Electronic Documents Signature

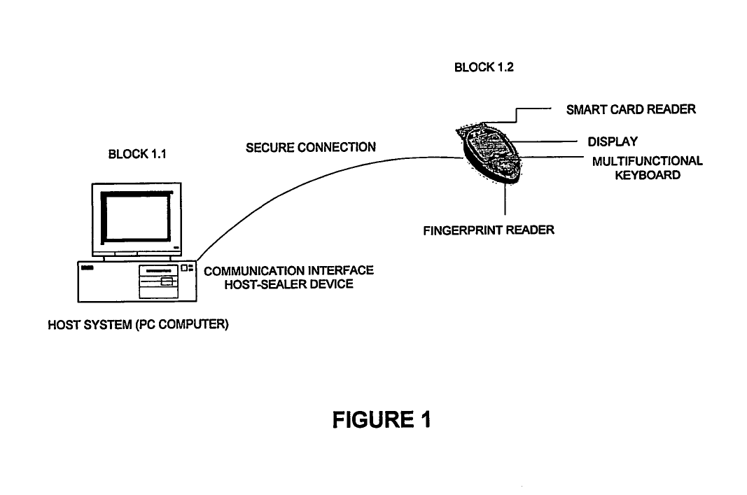

FIG. 1 presents a diagram of the embodiment of digital apparatus, block 1.2, named digital sealer device, which has the purpose of issuing digital signatures in secure form. The apparatus is connected to a host system (for example, a PC computer), block 1.1, through a high-speed communication interface.

FIG. 1 presents in block 1.2 the interface modules that constitute the digital sealer device, namely:
Communication gate with the host system
Communication gate with the auxiliary peripheral devices directly connected to the sealer device
Smart card reader
Fingerprint reader
Digital display
Multifunctional keyboard

The interface modules are in an injected plastic cabinet enclosure, with a device that blocks the physical access to the inner part of the digital sealer device and that its inlet and outlet operations be lonely intercepted. By this way, the subsequent stages of digital signature process (fingerprint obtainment, smart card opening, private key and digital certificate readout, signature generation and transference of the signed document to the host microcomputer) become protected.

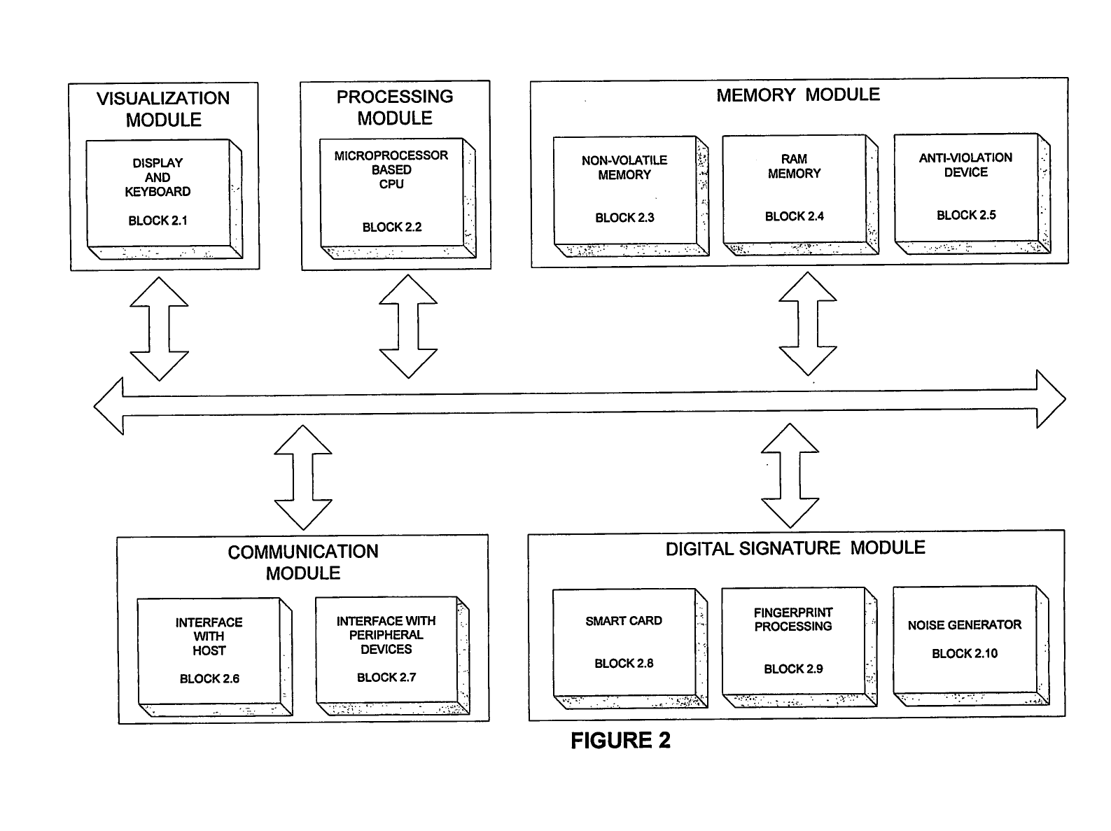

FIG. 2 presents the hardware modules that constitute the digital sealer device, namely:
Visualization module
Processing module
Memory module
Communication module
Digital signature module.

The visualization module, block 2.1, contains the interface for a digital display that has the function of exhibit the message to the user, sent by the host or emitted by the sealer device.

The processing module, block 2.2, presents a microprocessor-based processor, responsible for the control, digital signature generation and cryptography functions.

The memory module contains a non-volatile memory, block 2.3, for software, for cryptographic keys, for digital certificates and for digital configuration storage of the digital sealer device and a RAM memory, block 2.4, for performing the embarked software and temporary memory of the digital sealer device.

Additionally, the memory module contains an anti-violation protection device, block 2.5, which prevents undue access to confidential information stored in the apparatus.

The communication module is composed of a communication interface with the host system, block 2.6, and by an interface for connection of peripheral auxiliary devices directly in the sealer device (printer, etc.), block 2.7

The digital signature module is constituted by an interface with the smart card, by a digital printer interface e by a noise generator.

The smart card interface, block 2.8, is responsible for the communication protocols implementation between the sealer device and the smart card and control function of the smart card reader.

The fingerprint processing interface, block 2.9, is responsible for the fingerprint readout and processing.

The noise generator, block 2.10, has the purpose to supply high quality random numbers for the cryptography algorithms.

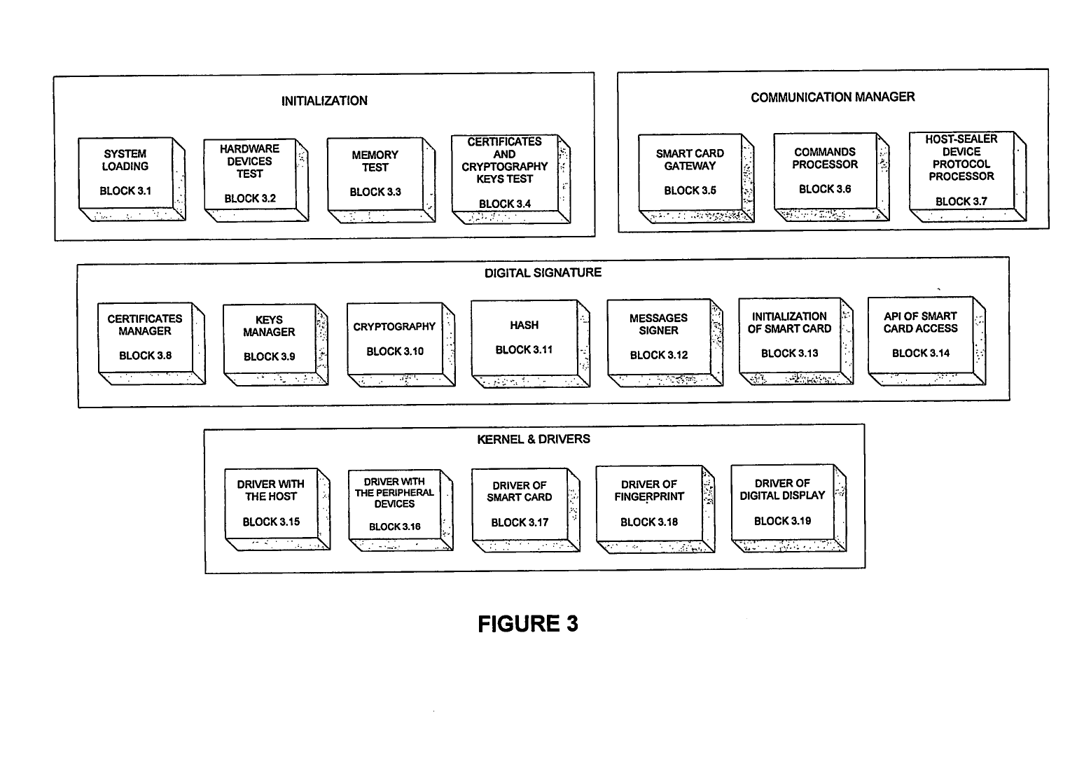

FIG. 3 describes and details the software modules that constitute the digital sealer device, namely;
Initializing Module
Communication Managing Module
Digital Signature Module
Kernel (Operational System Nucleus) and Drivers (Devices Controllers)

The initializing module is constituted by the system loading routines, block 3.1, the hardware devices test, block 3.2, the memory test, block 3.3, and the digital certificates and cryptographic keys tests, block 3.4.

The communication-managing module is constituted by the following elements: gateway with the smart card, in the commands processor and in the host-sealer device protocol processor.

The gateway with the smart card, block 3.5, is the responsible for the application messages treatment that flow directly between the host and the smart card. These messages are formatted according to standard ISO 7816 level 3 (APDU). The gateway decides which messages shall be transparently forwarded to the smart card and which shall receive partial or total treatment from the sealer device.

The commands processor, block 3.6, performs the sealer device commands sent by the host or the APDUs that the gateway, with the smart card, has submitted to be directly treated.

The host-sealer device protocol processor, block 3.7, is responsible for the integrity and for the confidentiality of communication between host-sealer device.

The digital signature module is constituted by the certificates manager, keys manager and cryptography, hash, messages signer, smart card initialization and API (Application Program Interface).

The certificates manager function, block 3.8, is to generate, install, renew, revoke and remove digital certificates in the sealer device.

The keys manager, block 3.9, is responsible for the generation of asymmetric keys, for the cryptography algorithms of public keys implemented in the sealer device, and symmetric ones (or of session), for the cryptography algorithms of secret key implemented in the sealer device.

The cryptography function, block 3.10, implements the asymmetric algorithms (RSA, ECC, between others) and the symmetric algorithms (3DES, RC2, AES, between others) used internally and externally of the sealer device.

The hash function, block 3.11, implements the irreversible cryptography algorithms (SHA-1, MD5, between others), used for generation and checking of digital signatures and for checking the own sealer device integrity.

The messages signer function, block 3.12, is to digitally sign the message sent by the host, with the private user's key stored in the smart card and to return it stored in a secure digital envelope signed by the sealer device.

The smart card initializing function, block 3.13, provides all resources necessary for creation and storage, in the smart card, of the cryptography keys, digital certificates and biometric information for positive identification of their title-holders. The process consists of: assembling all necessary components for a DC within the standard PKCS#10 (CSR), generate the public key and the private key of the title-holder user of the card, capture its fingerprints (templates) and record this information package in the private areas of the smart card. The function then sends the CSR package to the host to be validated by a CA and, receiving the DC of CA (CSR validated by CA), install it in the smart card, habilitating its use.

The API of smart card access, block 3.14, has as purpose to implement the authentication, readout and recording functions of the smart card.

The Kernel & Drivers module has as function the hardware control of the sealer device and is composed by the following devices drivers: communication with the host, block 3.15; communication with auxiliary peripheral devices, block 3.16, interface control with the smart card, block 3.17, interface control with de fingerprint reader, block 3.18, and digital display, block 3.19.

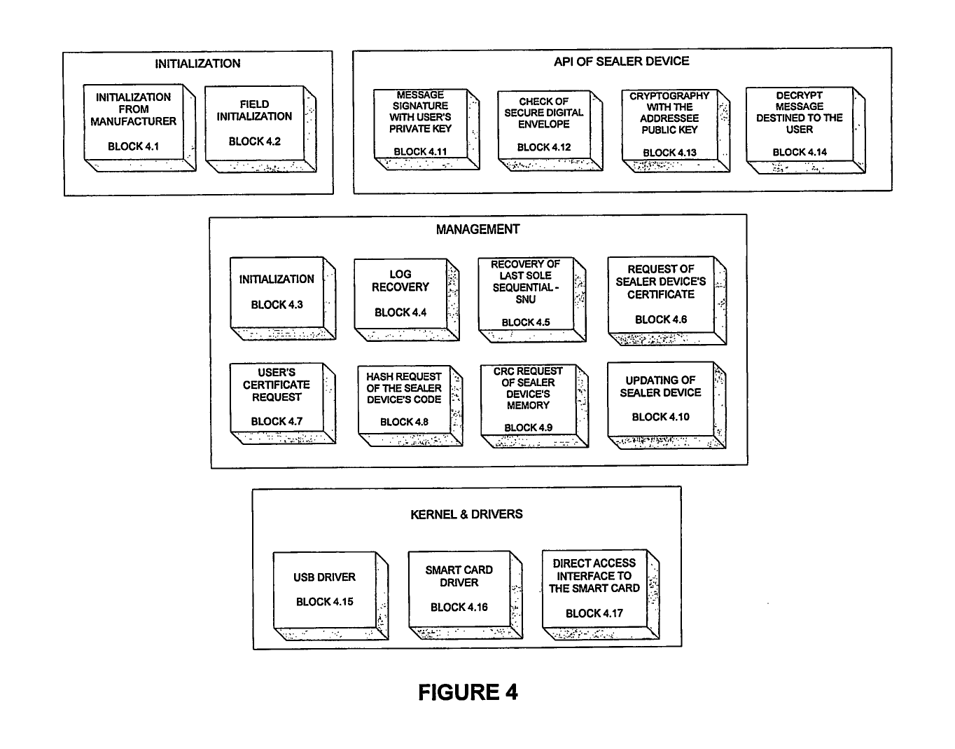

FIG. 4 describes and details the software modules that constitutes the host of the digital sealer device, namely:
Initializing functions module of the sealer device
Administrative functions module of the sealer device
Signature and cryptography functions module
Kernel & Drivers

The initializing functions module of the sealer device has as function to put the sealer device in operational status. It is composed by manufacturer's initializing routines, block 4.1, and by field initializing routines, block 4.2.

The manufacturer's initializing routines, block 4.1, has as purpose to install software, “engrave” the apparatus serial number in it, generate cryptographic keys, generate CSRs, and install DCs of CA and of manufacturer in the sealer device.

The field initializing routine, block 4.2, installs, renews, in the same certification authority, re-certifies, in another certification authority, the DC of the sealer device, and activates the sealer device (put it in operational status). Activation of the sealer device consists in generation, in the field, of the CSR's sealer device, its transmission to the manufacturer, its transformation in DC, and installation of this DC in the sealer device, that only then becomes able to operate.

The administrative functions module of the sealer device is constituted by the apparatus initializing routines (“turns on” the sealer device, synchronizing it with the host), block 4.3; by the log recovery (returns the last secure digital envelope transmitted to the host), block 4.4; by the last transaction identification recovery made by the sealer device (returns the last SNU—sequential number unique that identifies each secure digital envelope created by the sealer device), block. 4.5; by request of DCs stored in the sealer device (it may be of the own sealer device, of the manufacturer or one of the AC known by the sealer device), block 4.6; by the user's DC request (stored in the smart card), block 4.7; by the software hash request of the sealer device (for checking the software's integrity of the sealer device), block 4.8; by the request of CRC (Circular Redundancy Check) of the memory bands of the sealer device for checking its integrity, block 4.9; and by updating the sealer device (basic software, applicative software, internal parameters, dialogs and messages for the user, DCs installation and others), block 4.10. The updating of the sealer device is done by reception of one or more messages containing encrypted data files with the public key of the sealer device and digitally signed by the manufacturer of the sealer device. The sealer device, on receiving these messages, checks its integrity (check if the manufacturer's digital signature matches) and, if it matches, decrypts them (with its private key) and uses its content to update itself. The remainder functions of this block do not require to be digitally signed. All responses to administrative commands given to sealer device will be done by sending to the host the messages contained in secure digital envelopes digitally signed by the own sealer device, thus guaranteeing its originality (integrity and origin).

The functions module for signature and cryptography consists of signing with user's private key routines (stored in the smart card), block 4.11; of checking the integrity of a secure digital envelope, block 4.12; of message cryptography with the addressee's public key, block 4.13; and of message decryption addressed to the smart card title-holder user, block 4.14. In response to the routines of this module, the sealer device will send to the host the messages stored in secure digital envelopes, signed digitally by the own sealer device, thus guaranteeing its originality (integrity and origin). The messages will contain the processed message, in case of success, or an error message, in case some problem occurs whit it's processing.

The Kernel & Drivers module has as function the control of communications between host and sealer device and between this one and the external world. It is constituted by the communication driver host-sealer device, block 4.15, by the driver of communication (gateway) sealer device-external world, block 4.16 and by the interface for direct access to smart card, block 4.17.

A secure Application-Programming Interface for Access to the Sealer Device (APIsec)

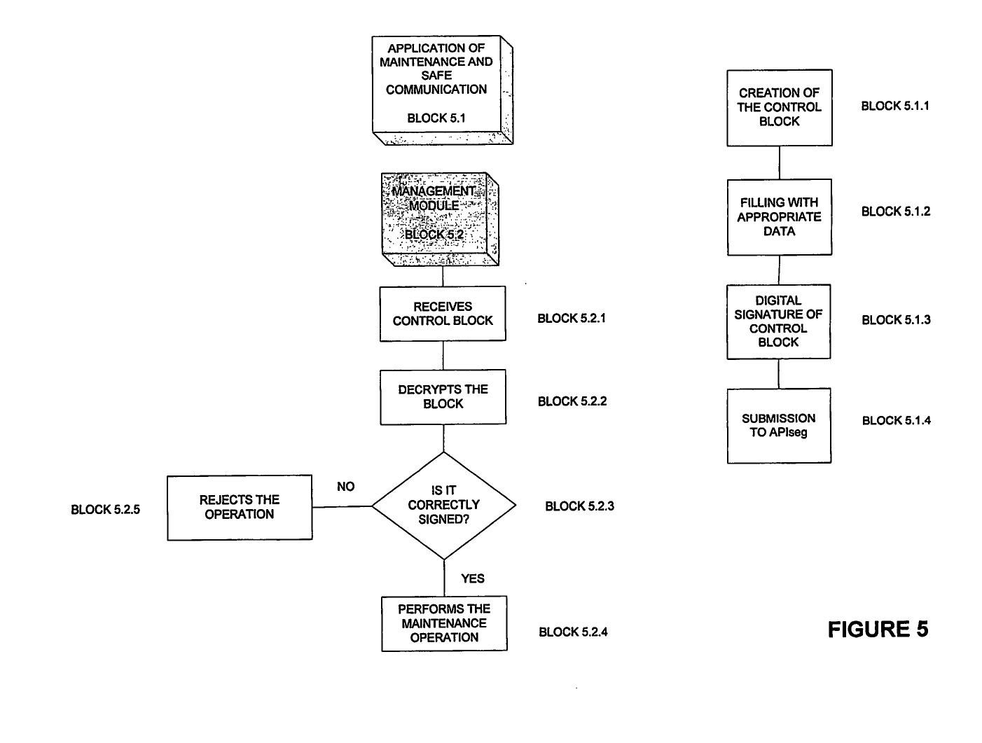

FIG. 5 shows a flowchart describing a secure programming interface of the present invention. The secure application programming interface (APIsec) is constituted by a set of functions available for an application program, block 5.1, which should need to perform sealer device management operations in secure form.

The management module, block 5.2, implements the transactions triggered by the microcomputer for maintenance of the sealer device.

Application, before submitting an operation via APIseg, shall perform a routine that comprehends the following steps: creation of the control block, block 5.1.1; filling the control block with the appropriate data, block 5.1.2; digital signature of control block, block 5.1.3; and submission of control block to APIseg, block 5.1.4.

The management module performs a routine that comprehends the following steps: control block reception, block 5.2.1; decrypts the block, block 5.2.2; tests to verify if the control block is correctly signed, with the user private key, block 5.2.3; performance of the requested operation, if the result of the test is positive, block 5.2.4; or rejection of the operation, if the result of the test is negative, block 5.2.5.

The secure API is the first barrier that guarantees the inviolability of digital signature operations of the own sealer device, as only applications made by the user of the sealer device, and duly certified by this sole user, are able to have access to the implemented facilities. By this way, any attack trial through the use of violence will be turned unviable by this local certification process.

Electronic Method for Private Area Opening of a Smart Card

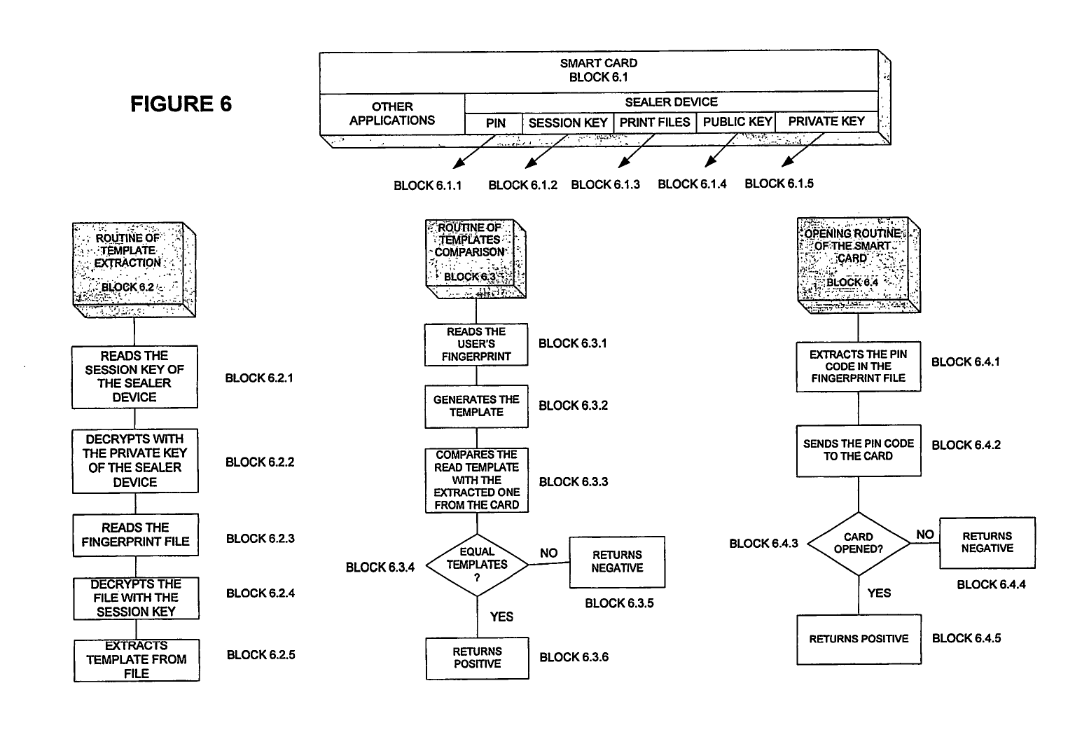

FIG. 6 shows a flowchart describing the structural and functional aspects of the smart card using the present invention. More specifically, it deals with an electronic method for opening the private area of a smart card starting from a digital printing template, constituted by:
a smart card, block 6.1;
a file containing the personal identification number (PIN) of card's owner, block 6.1.1;
a file containing the session key of the sealer device, block 6.1.2;
one or more files containing information related to fingerprints of card's owner, block 6.1.3;
a file containing the public key of the card's owner, block 6.1.4;
a file containing the private key of the card's owner, block 6.1.5;
extraction routine of fingerprint template, block 6.2;
fingerprint templates comparison routine, block 6.3;
smart card opening routine, block 6.4.

The card opening process starts with the execution of the template extraction routine, which is encrypted, with the session key of the sealer device, and stored in a file in the smart card.

The template extraction routine performs the following steps: key readout of the sealer device, stored in the smart card, block 6.2.1; session key decryption, using an adequate private key and the RSA algorithm, block 6.2.2; fingerprint file readout, block 6.2.3; fingerprint file decryption, using the session key of the sealer device and the triple-DES algorithm, block 6.2.4; fingerprint template extraction from the fingerprint file already decrypted, block 6.2.5.

After successful conclusion of the templates extraction routine, the next step is to check if the template extracted from the card is compatible with the fingerprint readout by the sealer device, through the fingerprint templates comparison routine. The following steps will be performed: user's fingerprint readout, block 6.3.1; generation of template of the fingerprint readout, block 6.3.2; comparison of the template of the fingerprint readout with the template extracted from the card, block 6.3.3, test to check if the templates match, block 6.3.4; return of a negative or positive response, according to the operation result, blocks 6.3.5 or 6.3.6, respectively.

Finally, the card opening routine is performed. The following steps will be performed: PIN code extraction from the fingerprint file formerly decrypted, block 6.4.1; sending of the PIN code to the card, block 6.4.2; test to check if the card was opened, block 6.4.3; return of a negative response if there was no success, block 6.4.4; otherwise, return of a positive response, block 6.4.5.

The method here described is embodied in an interception proof environment, as the sealer device, being an autonomous device, is not subject to have its memory or peripheral devices monitored by an external entity.

Electronic Method for User's Enrollment Using Fingerprint, Smart Card and Digital Certificate

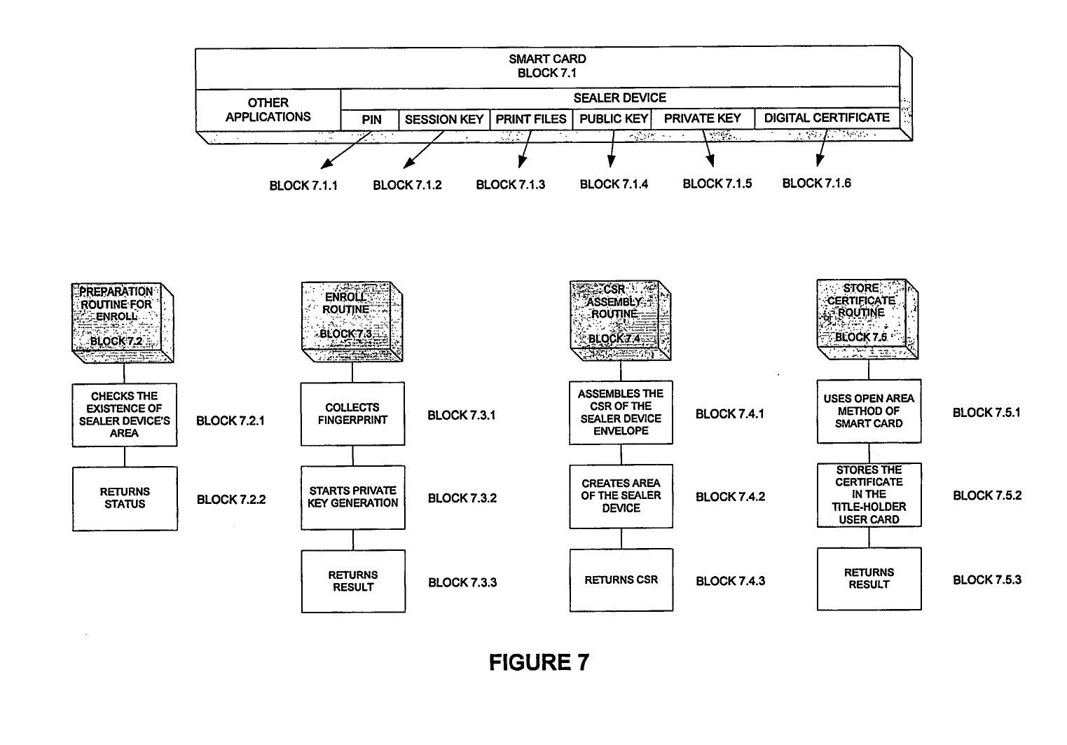

FIG. 7 describes the method for a fingerprint enrollment according to the present invention. More precisely, it deals with an electronic method for user's enrollment using fingerprint, smart card and digital certificate, comprising:
a smart card, block 7.1;
a file containing the personal identification number (PIN) of the title-holder user, block 7.1.1;
a file containing the session key created by the sealer device, block 7.1.2;
one or more files containing information related to biometric information of user's smart card title-holder, block 7.1.3, in the case of the present invention, the fingerprints of the user's smart card title-holder;
a file containing the public key of the card owner, block 7.1.4;
a file containing the private key of the card owner, block 7.1.5;
a file containing the digital certificate of the card owner, block 7.1.6;
preparation routine for enrollment, block 7.2;
enrollment routine, block 7.3;
Assembly routine of CSR, block 7.4;
Store Certificate Routine, block 7.5

The user's enrollment process starts with the execution of the preparation of the routine enrollment. This one is performed through a command emitted by the host system.

The preparation routine for enrollment performs the following steps: checks the existence of the sealer device's area in the smart card, block 7.2.1, and returns the result (positive or negative) to the host, block 7.2.2.

After successful conclusion of the preparation routine for enrollment, the host sends a enrollment command that activates the routine for enrollment, block 7.3. This routine collects the fingerprint and generates the printing template of this user, block 7.3.1. A template is a user's fingerprint mold obtained by the sealer device. The next step is to perform the user's private key generation process, block 7.3.2. Afterwards, the result of fingerprint collection is returned with its image, in case the collection has been positive, block 7.3.3.

The CSR assembling routine is performed after the host emits a CSR assembling command releasing the envelope preparation X.509 with proper information of the sealer device, block 7.4.1. A new area of the sealer device is created to receive the validated CSR, block 7.4.2, and the CSR already formatted is sent do the host, block 7.4.3.

Finally, the routine stores the certificate, activated by the host, initializes the private area in the smart card, block 7.5.1, stores the certificate in this private area, block 7.5.2, and completes the operation, returning to the host a process completion message, block 7.5.3.

The method here described is embodied in an interception proof environment, as the sealer device, being an autonomous device, is not subject to have its memory or its peripheral devices monitored by an external entity.

Electronic Method for Digitally Signing Documents from an User's Positive Identification

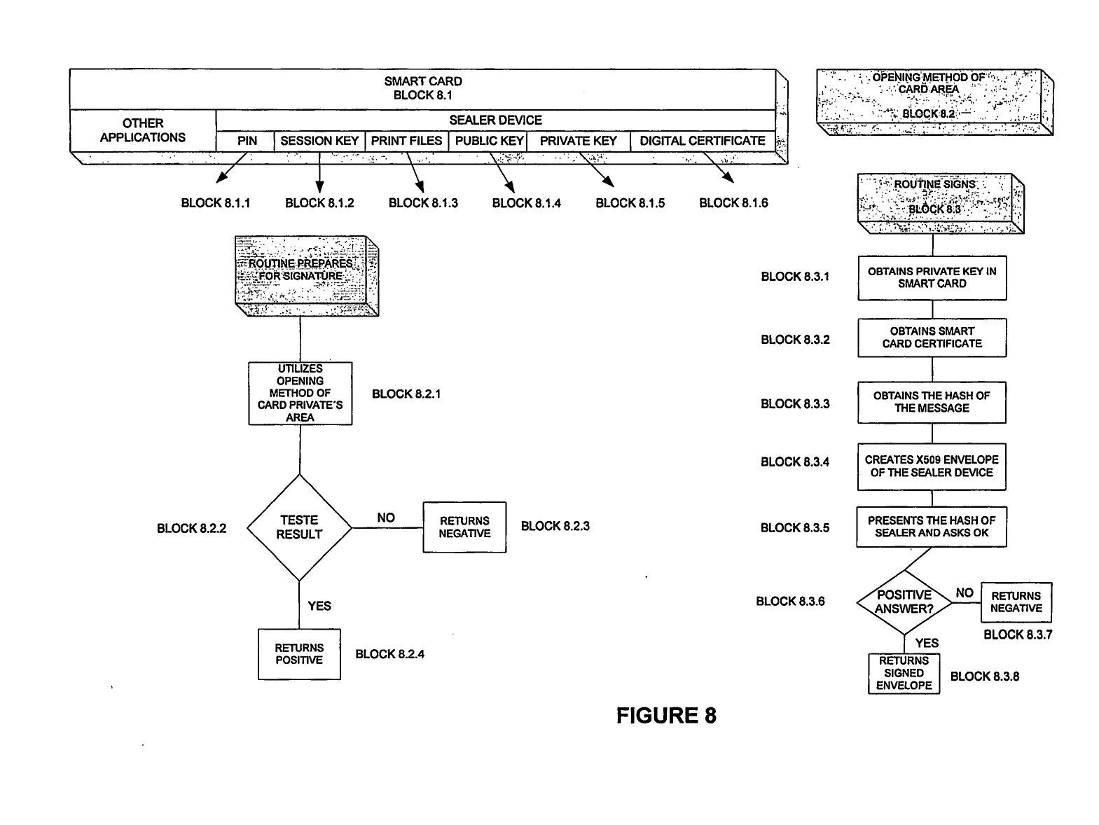

FIG. 8 shows a diagram of an electronic method for digital signature of documents from the positive identification of a user. Such a method consists of a smart card and a fingerprint template, containing the following elements:
a smart card, block 8.1;
a file containing the personal identification number (PIN) of the card owner, block 8.1.1;
a file containing the session key of the sealer device, block 8.1.2;
one or more files containing information related to the fingerprints of the card owner, block 8.1.3;
a file containing the public key of the card's owner, block 8.1.4;
a file containing the private key of the card's owner, block 8.1.5;
a file containing the digital certificate of the card's owner, block 8.1.6;
preparation routine for signing, block 8.2;
routine signs, block 8.3.

The signing process is started with the call of the opening method of the smart card area.

The preparation routine for signing performs the following steps: use of the opening method of the card private area, block 8.2.1; test to check the result of private area existence, block 8.2.2; return of negative response and process interruption, block 8.2.3, or of a positive response to effect the signature, block 8.2.4.

After positive confirmation of private area existence in the card, the signing routine is started, according to the following steps: obtainment of the user's private key in the card, block 8.3.1; obtainment of user's certificate in the card, block 8.3.2; hash performing (MD5 or SHA1) of the message, bloc 8.3.3; creation of the standard envelope X.509, block 8.3.4; presentation of the appropriate hash, block 8.3.5 and confirmation of request, block 8.3.6; the obtainment of the negative response interrupts the process, block 8.3.7; the positive response materializes the digital signature returning the standard envelope X.509 signed, block 8.3.8.

The method here described is materialized in an interception proof environment as the sealer device, being an autonomous device, is not subject to have its memory or its peripheral devices monitored by an external entity.

1. Digital sealer apparatus for electronic documents signature, characterized by comprehending:
fingerprint reader;
smart card reader;
digital signature generator;
communication interface;
RISC processor;
RAM memory;
non-volatile memory
noise generator
digital display
multifunctional keyboard

2. Secure application programming interface for access to a digital sealer apparatus, characterized by comprehending:
a secure interface for cryptographic recording of the sealer device keys;
a secure interface for signatures validation of the sealer device; and
an area of the sealer device containing the encrypted keys.

3. Electronic method for fingerprint enrollment using a digital sealer apparatus, characterized by comprehending the following steps:
user's data capture;
public and private key generation in the digital sealer apparatus;
collection of fingerprint in the digital sealer apparatus;
generation of template in the digital sealer apparatus;
generation of a password in the digital sealer apparatus;
recording of the password in the smart card;
recording of the template in the smart card; and
recording of public and private key in the smart card.

4. Electronic method for digitally signing documents from a positive identification of a user, characterized by comprehending the following steps:
transmission of microcomputer's document to a sealer device;
collection of user's fingerprint;
generation of a template;
readout of opening password of the smart card;
readout of the template from a smart card;
comparison of these two templates;
generation of the digital signature; and
transmission of the signed document to the microcomputer.
